(19) United States
(12) Patent Application Publication
(10) Pub. No.: US 2004/0059653 A1
(43) Pub. Date: Mar. 25, 2004

(54) System and method for rendering automated real property title decisions

(75) Inventors: Albert G. Verkuylen, Orange, CA (US); Ernest D. Smith, Santa Barbara, CA (US); Donald E. Partington, Irvine, CA (US); Mark Attaway, Irvine, CA (US)

Correspondence Address: BANNER & WITCOFF, 1001 G STREET N W, SUITE 1100, WASHINGTON, DC, 20001, US

(73) Assignee: Fidelity National Financial, Inc., Irvine, CA

(21) Appl. No.: 10/284,397

(22) Filed: Oct. 31, 2002

Related U.S. Application Data
(60) Provisional application No. 60/412,809, filed on Sep. 24, 2002.

(51) Int. Cl. G06F 17/60

(52) U.S. Cl. 705/35

(57) ABSTRACT

An apparatus and method is provided for rendering title decisions on an expedited basis. In light of empirical data showing a correlation between negative financial information (e.g., credit delinquencies) of a property owner/borrower and potential encumbrances on title to real estate owned by the property owner/borrower, a computer-implemented process evaluates financial information of a prospective mortgage applicant. If the financial information is favorable, an expedited title decision-making process is used to determine the adequacy and quality of the security to be pledged in connection with the mortgage transaction, as well as to assist in the process of issuance of title insurance products. If the financial information is not favorable, a full title search is performed. The invention significantly increases the speed of the mortgage application process without incurring substantial risks. A variation of the invention permits lenders to prescreen prospective mortgage applicants by determining whether they would qualify for an expedited title decision-making process. Those candidates who would qualify for the expedited title decision-making process are solicited for an expedited mortgage process.

### CROSS-REFERENCE TO RELATED APPLICATIONS

This application claims priority to U.S. provisional application serial No. 60/412,809, entitled “Method and System for Automatic Decision-Making in Loan Underwriting,” filed on Sep. 24, 2002. That application is hereby incorporated by reference.

### FIELD OF THE INVENTION

The invention relates generally to computer-implemented systems and methods for rendering automated real property title decisions. More specifically, the invention provides a process for rendering title decisions on the basis of non-title documents, such as financial information associated with the owner of the property.

### BACKGROUND OF THE INVENTION

The conventional process of financing or refinancing a mortgage can be time-consuming. The process includes several steps that must be completed before the mortgage can be closed. Most lenders require as a condition of a mortgage that the borrower obtain a title insurance policy on the mortgaged property. Title insurance insures the risk that a previously unknown encumbrance on the property (e.g., a mechanic's lien; a prior mortgage; a judgment or other court attachment; or an unpaid tax lien) will impair the value of the property, thus jeopardizing the lender's interests in the property. Title insurance companies typically insure such risks after inspecting title documents recorded at a local courthouse or maintained in an electronic database.

FIG. 1 shows in abbreviated form some of the steps involved in processing a mortgage for a piece of property, such as real estate. The process steps are illustrative and may differ depending on various factors such as whether it is a new mortgage or a refinance of an existing mortgage. The steps may also be performed in a different order from those illustrated, and some steps may be performed in parallel with others.

In step 101, a credit report and other qualification information (e.g., salary and employment history) is obtained from the borrower. This can be performed by a mortgage broker or direct lender, and may include various computer-implemented steps such as determining whether the borrower is qualified to undertake the mortgage. Assuming that the borrower is qualified for the mortgage, in step 102 a title search is ordered and a property appraisal is performed. After the title search, in step 103 a title insurance company issues a preliminary report and/or title insurance commitment based on the results of the search. This commitment may list exceptions to the title that must be satisfied at closing, such as paying off a tax lien or a previous mortgage.

In step 104, the mortgage and deed documents are prepared, and in step 105 the mortgage is closed (i.e., the documents are signed and finds are transferred). In step 106, any previous mortgages and liens on the property are paid off and new documents (e.g., the new deed and mortgage) are recorded at the courthouse or other location. Finally, in step 107, the title insurance policy is issued after any conditions in the preliminary report and title insurance commitment are satisfied.

The process illustrated in FIG. 1 has many bottlenecks that can slow down the closing. During periods of low interest rates, many borrowers attempt to refinance their mortgages at lower prevailing rates, creating large backlogs in mortgage processing at lenders and mortgage brokers. Although improvements in computer-implemented technology have speeded up certain steps of the process, such as credit qualification and property appraisal, one bottleneck in the process has remained—the title decision-making process. Many states require title insurance companies to inspect title documents prior to issuing a title insurance policy. Even where such regulations are not required, title insurance companies need a way of gauging and lowering risks associated with title insurance.

The conventional means of determining whether a given piece of property is likely to have title problems is to manually inspect deeds and other recorded documents at a local courthouse or other location where title and encumbrance information is stored. This process is labor-intensive and typically takes from three days to three weeks to perform. Depending on how property records are maintained, title examiners may need to search through grantor-grantee indices and other paper or electronic records to determine what mortgages, liens, easements, and other encumbrances might affect rights to a given piece of property. Because of this bottleneck, it is difficult if not impossible to speed up the mortgage process.

Another problem created by the bottleneck is that it is difficult for lenders to identify in advance good mortgage refinancing candidates in order to solicit mortgage refinancings. For example, although a lender may have information on the credit history of a particular borrower and can pre-screen the borrower for a solicitation to refinance his or her mortgage, the lender knows that the refinance process will include a title examination. Because there is presently no easy way to predict the outcome of the lengthy title examination process, lenders waste time and money soliciting potential borrowers who, because of various encumbrances on their property, ultimately may not qualify for refinancing their mortgage.

What is needed is a way of speeding up the process of evaluating title decision risks for a given piece of real property. What is also needed is a way of predicting in advance those properties that are likely to successfully qualify for an expedited title decision, thus allowing lenders to pre-screen borrowers whose mortgages could then be refinanced in a much shorter time period.

### SUMMARY OF THE INVENTION

The invention provides a system and method for making predictive title decisions on an expedited basis. The inventors have discovered that there exists a correlation between legal encumbrances on property (e.g., judgments and tax liens) and financial information associated with an owner or borrower on the property, such as delinquency patterns. According to the invention, a computer-implemented process evaluates probable risks that there are encumbrances on the property on the basis of financial information associated with an owner of the property. For example, the lack of adverse delinquency patterns associated with the owner of a given piece of property can lead to a conclusion that it is unlikely that there is an adverse judgment or unpaid taxes that might have caused a lien to be placed on the property. As another example, if a debt ratio attributable to a property owner exceeds a certain value, the risk that there is an unknown or undisclosed encumbrance on the property is increased.

Those properties that are determined to have a low risk of unknown encumbrances (i.e., those other than a primary mortgage on the property) are selected for accelerated title decisions. Those that fail the risk criteria are subjected to a conventional (and lengthier) title examination process. In one embodiment, the accelerated title insurance underwriting decision entails performing a “last vested deed/lien” search on the property, which is a much faster type of record examination than a conventional title search.

In another variation of the invention, potential borrowers are pre-screened to identify those who may qualify for an expedited title decision-making process. Those who meet the criteria for an expedited decision-making process are sent a solicitation to finance or refinance their mortgage. Because the solicitation is made only to those potential borrowers who qualify for the accelerated title decision-making process, the solicitation can promise extremely fast refinancing turn-around time to the prospective borrower, thus enhancing the marketing value of the solicitation.

Other embodiments, advantages and features will become apparent through the following description of the figures, specification and claims.

### BRIEF DESCRIPTION OF THE DRAWINGS

FIG. 1 is a flow chart showing process steps of financing or refinancing a mortgage according to a conventional process.

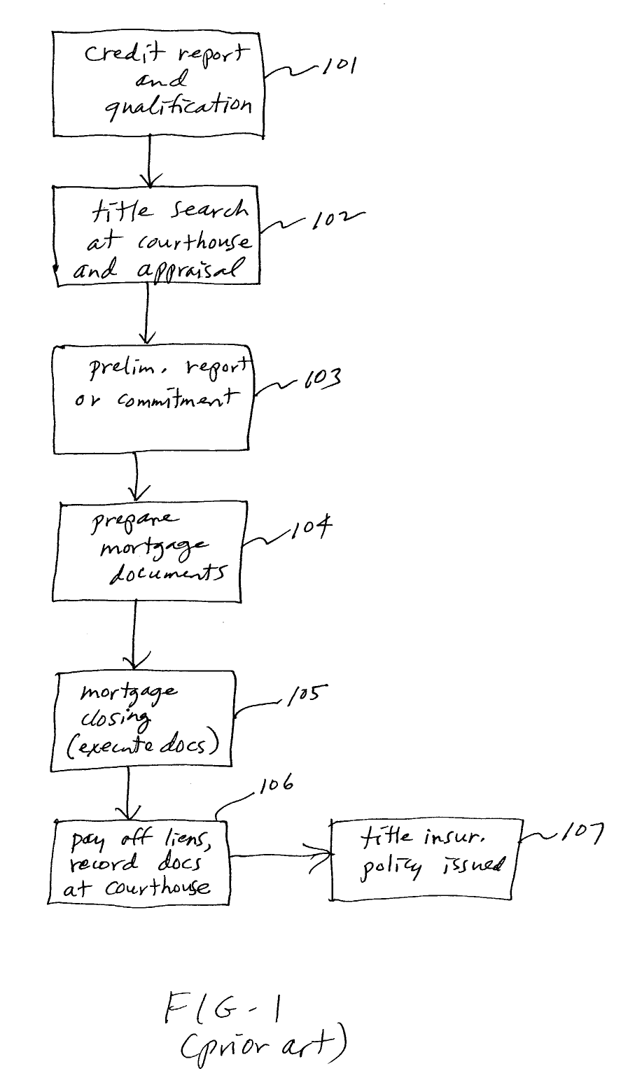

FIG. 2 is a flow chart showing process steps that may be practiced according to one variation of the present invention.

FIG. 3 is a flow chart showing process steps that may be practiced according to another variation of the present invention.

FIG. 4 shows a title decision-making engine operating on various data according to one variation of the present invention.

### DETAILED DESCRIPTION OF THE INVENTION

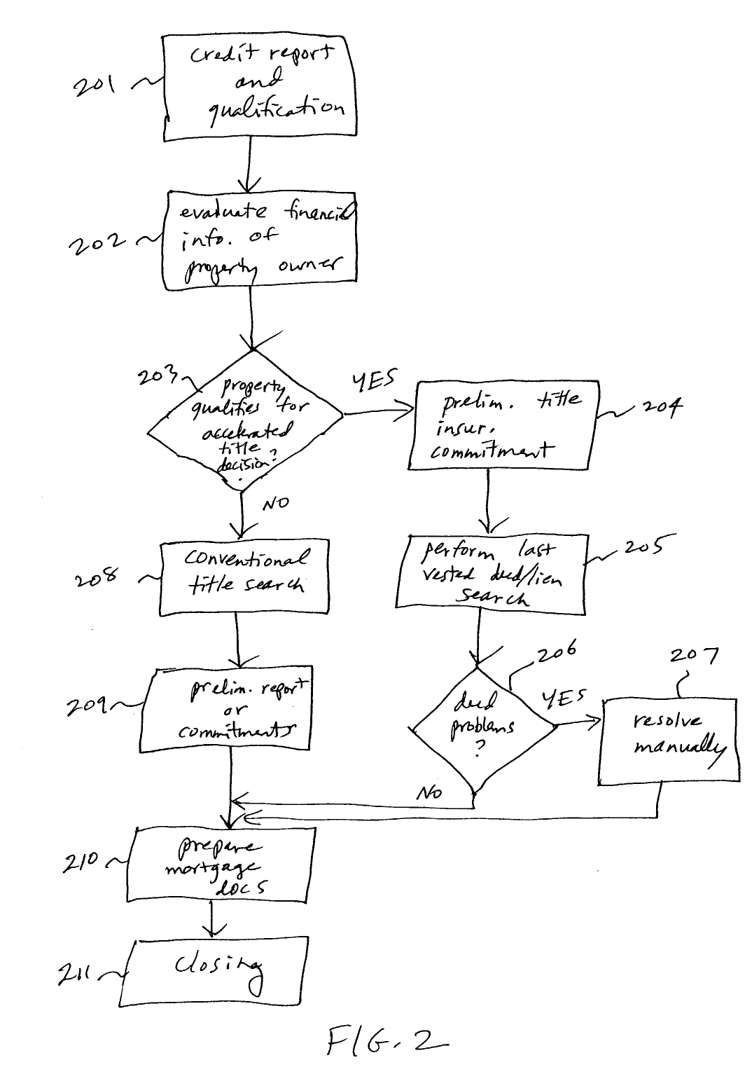

FIG. 2 shows in simplified form process steps that can be carried out according to the inventive principles. It will be understood that this process can be performed either for a new mortgage or for refinancing an existing mortgage, and that certain steps are omitted for clarity. Moreover, the invention need not include all those steps shown, as the scope of the invention is defined by the appended claims.

In step 201, the borrower's credit report and other qualification information is evaluated in the conventional manner. This step satisfies the lender that the borrower is able to afford the mortgage and is likely to timely repay the mortgage based on past credit history. However, this step does not determine whether a title decision can be made for the property that is the subject of the mortgage.

In step 202, financial information associated with the owner of the property that is the subject of the mortgage is evaluated to determine whether the property qualifies for an accelerated title decision. As explained in more detail below, this evaluation is different from and typically more detailed than the qualification and credit check evaluation that is done in step 201. Although steps 201 and 202 are shown as two separate steps, it may of course be possible to combine them into a single step.

If, in step 203, it is determined that the property qualifies for an accelerated title decision, then in step 204 a user may determine the type of insurance or non-insurance product they may want to obtain. In certain circumstances, a title insurer or title insurance agent may use the invention to facilitate the issuance of a preliminary title insurance commitment or its equivalent. Depending upon the user's underwriting criteria, the commitment may include one or more qualifications, such as a requirement that the last vested deed/lien search reveal no encumbrances other than a first or second mortgage, and that the ownership information provided by the borrower matches the ownership information shown by a last vested deed/lien search.

In step 205, a last vested deed/lien search is performed on the property to verify, among other things, that the property is currently vested in the prospective borrower. This step can often be performed very quickly, because current vesting information is frequently available in electronic form from databases maintained by municipalities. In contrast to a conventional title search, which requires extensive searches through grantor/grantee indices, this search can be performed by querying one or more databases using various property descriptions and the purported property owner's name.

If in step 206 no problems are detected (e.g., the last vested deed information matches the prospective borrower's name information and no unexpected liens are discovered), the process continues at step 210 (prepare mortgage documents). After mortgage documents are prepared, the closing takes place in step 211 as is conventional.

If in step 206 problems are discovered with the last vested deed/lien search (e.g., the owner of the property as reflected in the last vested deed does not match the borrower's information, or a lien is discovered during this search), then in step 207 the problems are resolved manually or overridden by the user. If the problems cannot be resolved, the applicant is removed from the expedited process and it may be necessary to perform a more extensive title search.

If in step 203 the property did not qualify for accelerated title decision, then in step 208 a conventional title search is performed, and in step 209 a preliminary report or commitment is issued. Processing thereafter continues as is conventional.

In one variation of the invention used by a title insurer, a streamlined title insurance policy may be issued. In this approach, a master title insurance policy is agreed upon in advance between the lender and the title insurance company, and all policies issued by the title insurance company are issued under this master policy. Rather than issuing an individual policy at the end of each mortgage process, the title insurance company can issue a certificate pertaining to the borrower that was the subject of the expedited underwriting decision. The master policy may include certain standard exclusions, such as exclusions for a tax lien for the current tax year, and for common easements such as utilities and drainage easements that are usually publicly recorded, easily ascertainable, and normally shown as exceptions to coverage in individually-issued policies.

In certain embodiments, the accelerated decision-making can be performed entirely by computer and without human intervention, leading to title decisions (and possibly the issuance of preliminary title insurance commitments) in a matter of minutes. In other embodiments, human review or intervention may be appropriate or required depending on the particular circumstances.

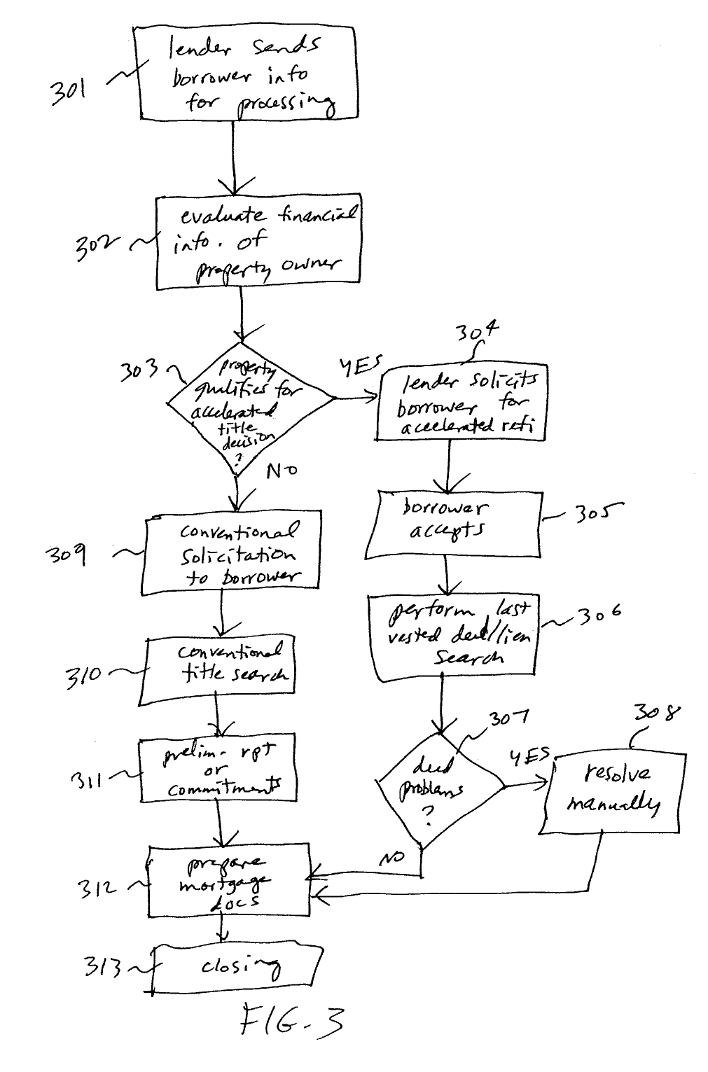

FIG. 3 shows a different variation of the process in accordance with the invention. Instead of starting with a borrower supplying qualification information, the process begins in step 301 with a lender or mortgage broker sending information regarding potential applicants to the user of the invention for evaluation. The lender may know, for example, that certain of its borrowers are candidates for refinancing and have excellent payment histories. But before soliciting these borrowers for a transaction, the lender first wants to ensure that the property that will be the subject of a refinancing transaction will qualify for an expedited title decision. In other words, the lender can derive substantial marketing advantages by soliciting borrowers with a promise that the entire financing or refinancing transaction can be performed in a matter of days, rather than weeks. Therefore, in step 301 the lender transmits a data file to the user of the invention with the names and identifying information of borrowers who are to be pre-qualified for this expedited title decision-making process. This information also includes the property address that is the subject of the potential mortgage financing or refinancing transaction.

In step 302, the user of the invention (for example, a title insurance company) evaluates financial information associated with the prospective borrowers that was transmitted in step 301. As described in more detail below, this evaluation is typically different from and more extensive than the mortgage pre-qualification checks that are commonly done to evaluate a borrower's repayment risks. Instead, this evaluation focuses on identifying factors that are likely to lead to legal encumbrances on the property, and may be implemented as a set of rules specific to a particular lender.

In step 303, if the property qualifies for accelerated title decision-making process, then in step 304 the lender solicits the borrowers having property that qualifies for an accelerated process (for example, an accelerated refinancing process). In particular, the solicitation (e.g., a letter or e-mail) can promise to complete the transaction within a few days, thus enhancing the marketing impact of the solicitation. In step 305, one or more of the borrowers accepts the offer to finance or refinance using the streamlined process.

In step 306, a last vested deed/lien search is performed based on the borrower's name and property information. This search locates the last recorded deed for the subject property and liens associated with the property. Because this information is frequently available in electronic databases, an extensive search at the courthouse or other document recordation location can be avoided, and the results can be returned in a matter of minutes. A check is performed to ensure that the persons who will be named on the mortgage correspond to the property owners of record on the last vested deed. If the names do not match, the check fails.

If in step 307 there are problems with the deed or liens, they can be manually resolved in step 308 or, if not resolvable, the borrower can be placed back into the conventional non-streamlined process. If there were no problems, then in step 312 the normal procedures of preparing mortgage documents are undertaken, and the mortgage is closed in step 313.

If in step 303 the property is deemed to not qualify for accelerated processing, then in steps 309 through 313 the conventional process is followed

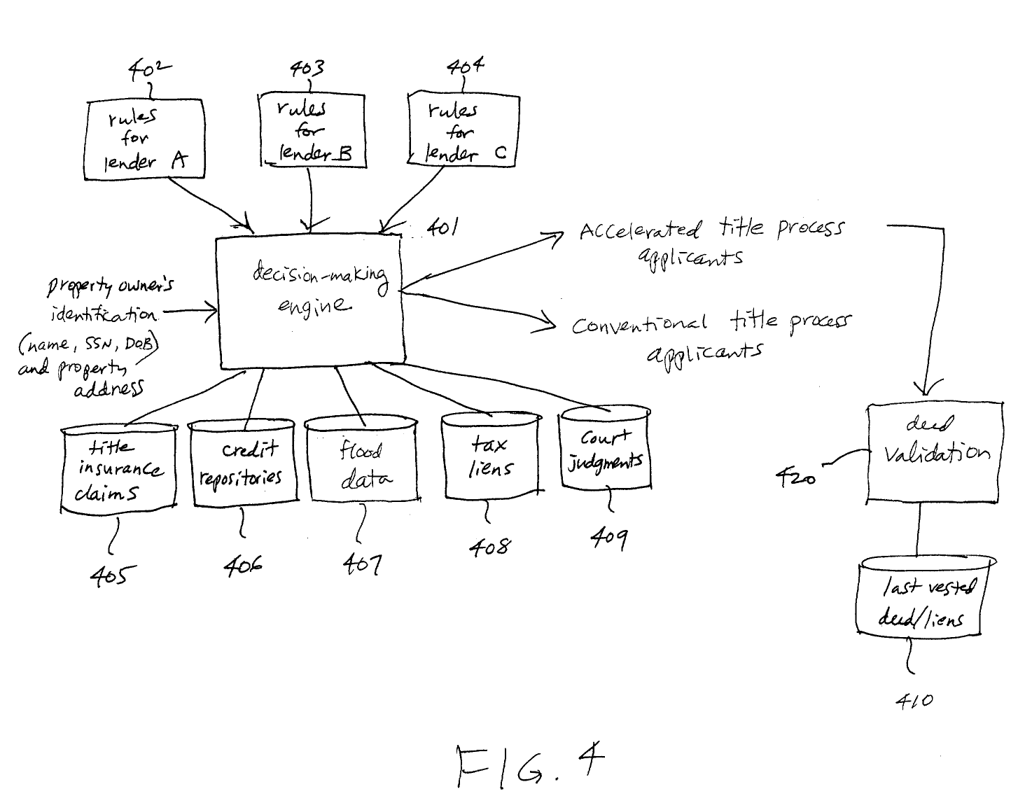

FIG. 4 shows a system operating according to various principles of the invention. A title decision-making engine 401, which may be implemented in computer software executing in a general-purpose computer, determines on the basis of financial information pertaining to a property owner or borrower whether an accelerated title decision-making procedure can be used. Engine 401 receives property owner information (e.g., name, social security number, and dates of birth) corresponding to the property owner/borrower and applies rules 402 to 404 and databases 405 to 409. In one embodiment, engine 401 is able to use different evaluation rules for each lender that is the subject of a title decision. For example, one set of rules 402 can be used to provide accelerated title decisions for a first lender A, whereas different sets of rules 403 and 404 can be applied to different lenders. Examples of specific rules are given below. Of course, the inventive principles will also work if only a single set of rules is used, or if rules are allocated differently across organizational entities.

Engine 401 applies rules pertaining to a specific property owner/borrower against one or more databases 405 to 409. The databases may include, for example:

Title insurance claims database 405. This database lists claims made against title insurance policies by the property owner. Prior claims made by a property owner can be an indication of future problems with title insurance on a different piece of property. Consequently, some of the rules can use this information to reject accelerated title decisions for some property owners. The claims database may include claims made against the lender's title insurance company or against the borrower's title insurance company or both.

Credit repositories 406. This may comprise separate databases including credit information obtained from different credit reporting services, such as Equifax, Experian, and TransUnion. In one variation of the invention, credit information from two different credit reporting services is obtained and cross-referenced to identify potential problems. Negative information contained in the credit repositories can be used to evaluate whether an accelerated title decision-making procedure will be followed. For example, a lack of delinquencies can lead to the conclusion that the property owner is unlikely to have adverse judgments (e.g., credit card defaults) resulting in liens on the property. Other examples of credit information used in rules are provided below.

Flood database 407. This database may indicate whether the property is in a flood zone or has been the subject of a flood. If so, further investigation may be required and an accelerated title decision can be avoided.

Tax liens database 408. This database may contain tax information relating to various borrowers and properties. If the borrower has had a tax lien filed against property that he or she owns, it could affect the likelihood that the subject property may also be the subject of a tax lien, and a full title search should turn up the lien.

Court judgments database 409. This database may contain information culled from various court jurisdictions indicating adverse judgments against the borrower. Examples include foreclosures; credit card or loan defaults; breaches of contract; bankruptcies; child support orders; and the like. Open judgments of this type may indicate a higher likelihood that a lien or attachment on the subject property exists, which will likely be turned up in a full title search.

Other databases (not shown) can also be consulted to identify such things as trade delinquencies; other mortgages; state statutes and regulations (e.g., certain states have regulations that might inhibit accelerated title decision-making); and the like.

Based on applying various rules to the data obtained from one or more databases, engine 401 segregates applicants into either an accelerated title decision-making category or a conventional decision-making category. As described above, conventional title decision-making is processed using conventional title searching techniques.

Accelerated applicants, however, are processed through deed validation process 420, which evaluates the last vested deed and liens on the subject property (database 410). As explained above, the last vested deed information can frequently be obtained in electronic form using databases that are sold by municipalities or maintained by various private vendors. Deed validation process 420 compares the borrower's information with the last vested deed to determine whether there is a match. For a refinancing, for example, the current borrower's name should match the current legal owner's name information on the last vested deed. If there are two co-borrowers, the last vested deed should indicate both names. Any recorded liens on the property will also produce a negative validation result according to one variation of the invention. Conventional easements, such as utility or conservation easements, can be ignored in some variations of the invention.

Depending on how and where they have been recorded, easements and liens may be manifested through the use of certain keywords that can be matched to known locales. For example, one county may record utility easements using certain codes or words that differ slightly from those used by another county. Depending on the breadth of the databases used, it may be necessary to parse the electronically stored information to match recorded easements and liens to known types of encumbrances. Similarly, property owner names can sometime be listed in first name/last name order or last name/first name order. Deed validation process 420 may include software to match names and encumbrance types based on parsing of the document and/or field matching software.

Various types of rules can be created to segregate those applicants who will receive accelerated underwriting processing from those who do not receive such processing. As set forth above, different rules can be created for different lenders and for different geographic locations. For example, because some states have stringent and detailed title decision-making requirements, rules can be created to automatically reject applicants whose property is located in those states. In one variation of the invention, all rules for a given lender or other entity must be satisfied in order to qualify for accelerated title decision-making. If one rule is not met, the applicant is not qualified for accelerated processing. Examples of rules include:

(1) FICO or credit score must be greater than X, where X can be a variable.

(2) Borrower has X 30-day delinquent payments on any real property credit, such as first mortgages, second mortgages, or home equity lines of credit, where X can be a variable such as zero.

(3) Borrower has X 60-day late payments on any accounts for past 12 months, where X can be a variable such as zero.

(4) Borrower has X other mortgages, where X can be a variable such as zero.

(5) Borrower has X foreclosures, where X can be a variable such as zero.

(6) Borrower has X bankruptcies, where X can be a variable such as zero.

(7) Borrower has X tax liens, where X can be a variable such as zero.

(8) Borrower has X open judgments, liens, child support liens, city, state or federal liens, where X can be a variable such as zero.

(9) Property is not located in a particular state.

(10) Borrower/property has no prior title insurance claims.

(11) Loan-to-value ratio (LTV) is less than X, where X can be a variable.

(12) Aggregate value of collection amounts in credit repositories is less than X % of equity in the property. (Note: this allows for the possibility that the borrower owes a small amount, for example due to a dispute with a vendor, and yet the amount is small compared to the borrower's equity in the property based on the appraised value or previous sales price of the property compared to the mortgage amount).

(13) Property valuation according to automated valuation model (AVM) has a good confidence level to support the proposed mortgage loan-to-value (LTV) ratio.

The above rules are merely exemplary. It will be appreciated that rules may be combined and different values for the variable X can be used to qualify different applicants for accelerated underwriting decisions. For example, a combination of rules (1), (2), and (3) may be used for qualifying applicants in connection with one lender, whereas a slightly different version of rules (1), (3), and (5) may be used for qualifying applicants in connection with a different lender.

The engine 401 shown in FIG. 4 may receive applicant information from various sources over the Internet and/or in batch form. The data may be formatted using XML standard file formats; comma-delimited flat files; or tab-delimited flat files. Data may be transmitted using HTTP protocols. Data from the various sources (e.g., applicant data and data culled from various databases) may be formatted into a standard format for evaluation by the decision-making engine. In one embodiment, rules may be stored in such a way that they can be modified over the Internet as needed. Additionally, results of the process can be reported on a web-accessible site.

Although the decision-making engine 401 is shown as a single unit, the functions performed by this engine may be performed by a plurality of smaller functions that are partitioned or replicated as dictated by a particular design. In one embodiment, the functions make use of RealEC™ MSMQ Message Queuing Infrastructure and COM+based components.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. Any of the method steps described herein can be implemented in computer software and stored on computer-readable medium for execution in a general-purpose or special-purpose computer, and such computer-readable media is included within the scope of the intended invention.

We claim:

1. A computer-assisted process of rendering real property title decisions, comprising the steps of:
(1) evaluating financial information associated with a property owner for property that is the subject of an underwriting decision;
(2) in response to favorable evaluation of the financial information, initiating an expedited title decision-making process that does not require a full property title search; and
(3) in response to an unfavorable evaluation of the financial information, rejecting the expedited title decision-making process.

2. The computer-assisted process of claim 1, wherein step (1) comprises the step of evaluating a credit score associated with the property owner.

3. The computer-assisted process of claim 1, wherein step (1) comprises the step of evaluating payment delinquencies for the property owner.

4. The computer-assisted process of claim 1, wherein step (1) comprises the step of evaluating adverse court judgments against the property owner.

5. The computer-assisted process of claim 1, wherein step (1) comprises the step of evaluating prior title insurance claims attributable to the property owner.

6. The computer-assisted process of claim 1, wherein step (1) comprises the step of evaluating a loan-to-value ratio attributable to the property.

7. The computer-assisted process of claim 1, wherein step (1) comprises the step of evaluating whether collection amounts attributable to the property owner in one or more credit repositories are less than a predetermined fraction of equity in the property.

8. The computer-assisted process of claim 1, wherein step (1) comprises the step of evaluating a confidence level in a property value on the basis of an automated valuation model (AVM).

9. The computer-assisted process of claim 1, wherein step (1) comprises the step of applying a plurality of rules in a computer to credit data obtained from a plurality of credit repositories regarding the property owner.

10. The computer-assisted process of claim 1, wherein step (2) comprises the step of performing a last vested deed title search using an electronic database.

11. The computer-assisted process of claim 10, wherein step (2) comprises the step of verifying that the name of the property owner matches the name recorded on the last vested deed for property that is the subject of the title decision.

12. The computer-assisted process of claim 11, wherein step (2) comprises the step of verifying whether there are any liens on the property as reflected in the last vested deed title search.

13. The computer-assisted process of claim 11, further comprising the step of, in response to a favorable evaluation in step (2), issuing a certificate to a master title insurance policy, wherein the certificate pertains to a borrower.

14. The computer-assisted process of claim 1, further comprising the step of, in response to a favorable evaluation in step (2), issuing a preliminary title insurance commitment.

15. The computer-assisted process of claim 1, wherein step (1) comprises the step of applying a plurality of rules against data collected from a title insurance claims database; a credit repository; a flood database; a tax lien database; and a court judgments database.

16. The computer-assisted process of claim 1, wherein step (1) comprises the step of applying a plurality of rules to non-title financial data, wherein the plurality of rules differs depending on a lender that is to be used for a mortgage financing transaction.

17. A computer-assisted process of pre-screening candidates for mortgages, comprising the steps of:
(1) receiving information identifying a plurality of prospective mortgage candidates and corresponding property addresses;
(2) evaluating on the basis of financial information pertaining to each prospective candidate whether an expedited title decision can be provided, wherein the expedited title decision potentially avoids the need for a full title search; and
(3) for each prospective refinancing candidate that is evaluated in step (2) to qualify for an expedited title decision, sending a solicitation to such prospective candidate offering an expedited mortgage financing process.

18. The computer-assisted process of claim 17, wherein step (2) comprises the step of evaluating a credit score of each prospective candidate.

19. The computer-assisted process of claim 17, wherein step (2) comprises the step of evaluating payment delinquencies for each candidate.

20. The computer-assisted process of claim 17, wherein step (2) comprises the step of evaluating adverse court judgments for each candidate.

21. The computer-assisted process of claim 17, wherein step (2) comprises the step of evaluating prior title insurance claims attributable to each candidate.

22. The computer-assisted process of claim 17, wherein step (2) comprises the step of evaluating a loan-to-value ratio attributable to each candidate.

23. The computer-assisted process of claim 17, wherein step (2) comprises the step of evaluating whether collection amounts attributable to each candidate in one or more credit repositories is less than a predetermined fraction of equity in property that will be the subject of the financing.

24. The computer-assisted process of claim 17, wherein step (2) comprises the step of evaluating a confidence level in a property value on the basis of an automated valuation model (AVM).

25. The computer-assisted process of claim 17, wherein step (2) comprises the step of applying a plurality of rules in a computer to credit data obtained from a plurality of credit repositories regarding each candidate.

26. The computer-assisted process of claim 17, further comprising the steps of, in response to an acceptance by one of the candidates:
(4) performing a last vested deed title search for property that is the subject to the financing; and
(5) confirming that a name on the last vested deed matches the name of the one candidate.

27. A method of processing a mortgage transaction for a prospective borrower with respect to real property, comprising the steps of:
(1) performing a credit check and mortgage qualification for the prospective borrower;
(2) causing to be performed a computer-implemented title evaluation, including the step of determining on the basis of credit information relating to the prospective borrower whether an expedited title decision-making process can be used and, if so, initiating a limited title search of the property and, if not, initiating a full title search of the property;
(3) obtaining a title insurance commitment; and
(4) preparing mortgage documents for a closing.

28. The method of claim 27, wherein step (2) comprises the step of evaluating a credit score of the prospective borrower and, if the credit score exceeds a predetermined value, initiating the limited title search of the property.

29. The method of claim 28, wherein the limited title search comprises the step of performing a last vested deed title search using an electronic database.

30. The method of claim 28, wherein step (2) comprises the step of applying a plurality of computer-implemented rules that compare data obtained from one or more credit repositories; a title insurance claims database; a flood database; a tax liens database; and a court judgments database.

31. A computer comprising a title decision-making engine including computer-executable instructions that perform the steps of:
(1) evaluating non-title financial information associated with a property owner for property that is the subject of a title decision;
(2) in response to favorable evaluation of the non-title financial information, initiating an expedited title decision-making process including only a limited title search; and
(3) in response to an unfavorable evaluation of the non-title financial information, rejecting the expedited title decision-making process.

32. The computer of claim 31, wherein step (1) comprises the step of evaluating a credit score associated with the property owner.

33. The computer of claim 31, wherein step (1) comprises the step of evaluating payment delinquencies for the property owner.

34. The computer of claim 31, wherein step (1) comprises the step of evaluating adverse court judgments for the property owner.

35. The computer of claim 31, wherein step (1) comprises the step of evaluating prior title insurance claims attributable to the property owner.

36. The computer of claim 31, wherein step (1) comprises the step of evaluating a loan-to-value ratio attributable to the property.

37. The computer of claim 31, wherein step (1) comprises the step of evaluating whether collection amounts attributable to the property owner in one or more credit repositories is less than a predetermined fraction of equity in the property.

38. The computer of claim 31, wherein step (1) comprises the step of evaluating a confidence level in a property value on the basis of an automated valuation model (AVM).

39. The computer of claim 31, wherein step (1) comprises the step of applying a plurality of rules in a computer to credit data obtained from a plurality of credit repositories regarding the property owner.
